(19) United States
(12) Patent Application Publication
(10) Pub. No.: US 2026/0084970 A1
(43) Pub. Date: Mar. 26, 2026

(54) PITCH-BASED COMPOSITE POWDERS CONTAINING A GRAPHITIZATION CATALYST AND METHODS FOR PRODUCTION AND USE THEREOF

(71) Applicant: ExxonMobil Technology and Engineering Company, Spring, TX (US)

(72) Inventors: Krishnan Anantha Narayana Iyer, Baytown, TX (US); Ali H. Slim, Baytown, TX (US); Shiun Ling, Annandale, NJ (US); Li Wang, Shanghai (CN); Liang Li, Shanghai (CN); Caiguo Gong, Houston, TX (US)

(73) Assignee: ExxonMobil Technology and Engineering Company, Spring, TX (US)

(21) Appl. No.: 19/407,916

(22) Filed: Dec. 3, 2025

Related U.S. Application Data
(63) Continuation of application No. PCT/US2024/033737, filed on Jun. 13, 2024.
(60) Provisional application No. 63/508,397, filed on Jun. 15, 2023.

(51) Int. Cl. C01B 32/205; H01M 4/587; H01M 10/0525

(52) U.S. Cl. CPC C01B 32/205; H01M 4/587; H01M 10/0525; C01P 2002/02; C01P 2002/74; C01P 2002/88; C01P 2006/40

(57) ABSTRACT

Composite powders for electrode production may be formed by blending a graphitization catalyst or precursor thereof with petroleum pitch under grinding conditions. The composite powders may comprise about 0.1 wt. % to about 30 wt. % graphitization catalyst or a precursor thereof, based on total mass of the composite powder, and about 20 wt. % to about 99.9 wt. % petroleum pitch, based on total mass of the composite powder. The graphitization catalyst or the precursor thereof is dispersed in a matrix comprising the petroleum pitch, and the petroleum pitch comprises a plurality of pitch particles. The composite powders may be subsequently carbonized and then graphitized under conditions that may be less severe than un-catalyzed graphitization. The grinding conditions for forming the composite powders may include melt blending to form a continuous pitch matrix, wherein at least a portion of the graphitization catalyst or the precursor thereof may be dispersed within an interior of the pitch particles.

### CROSS-REFERENCE TO RELATED APPLICATIONS

The present application is a continuation of International Patent Application No. PCT/US2024/033737, filed Jun. 13, 2024, which claims priority to U.S. Provisional Patent Application No. 63/508,397 filed Jun. 15, 2023, the entire disclosures of which are incorporated herein by reference in their entirety.

### FIELD

The present disclosure relates to composite powders and, more particularly, to composite powders containing petroleum pitch or derived from petroleum pitch.

### BACKGROUND

Graphite is a carbon allotrope consisting of a great number of stacked sheets of sp²-hybridized carbons arranged in a highly ordered structure. Among the many beneficial attributes of graphite are its high thermal and electrical conductivity values, the latter of which may make graphite especially useful as an electrode material in batteries, for instance. In addition, the crystalline structure of graphite promotes an ability to store lithium ions through intercalation, which is useful for lithium-ion battery applications. Additional applications in which graphite finds extensive use include, for example, fiber production, composite manufacturing, lubrication, and as electrodes for electric arc furnaces.

Graphite may be obtained from natural sources or produced synthetically through pyrolysis of a carbonaceous precursor. The latter material is referred to herein “synthetic graphite.” Suitable carbonaceous precursors for producing synthetic graphite include cokes and petroleum pitches, each of which contain large aromatic molecules that may be converted to graphite under pyrolysis conditions. For example, the large aromatic molecules in coke and petroleum pitches may first be converted to amorphous carbon in a carbonization process taking place at a temperature of about 700° C. to about 1800° C., followed by subsequent conversion of the amorphous carbon to graphite in a graphitization process taking place at a higher temperature of about 2800° C. to about 3400° C. Both conversion processes take place in the absence or substantial absence of oxygen. To achieve a high-percentage conversion of previously formed amorphous carbon to graphite (e.g., greater than 90% conversion of amorphous carbon to graphite on a mass basis), temperatures up to and exceeding 3000° C. and extended reaction times up to about 20 hours are frequently needed. Because such extended, high-temperature conversion processes are exceedingly energy intensive, the production of synthetic graphite remains expensive, despite the low cost of coke and petroleum pitch as graphite precursors. Commercial graphitization processes may further employ a range of graphitization temperatures, which may impact the quality of the graphite produced therefrom.

Lithium-ion batteries adoption has seen significant increase due to their use in electric vehicles, stationary energy storage, and for portable electronic devices. Synthetic graphite has become the material of choice for lithium-ion battery negative electrodes. The key consideration for negative electrode includes high volume and gravimetric capacity, long charge-discharge cycle life, and faster charging speeds. Graphite anode materials designed for high power capacity and performance such as those used in EVs require a layer of protective amorphous carbon coating to protect the underlying graphite sheets from electrolyte inside the cell. Additionally, the graphite materials for negative electrode are often ground to <10 micron size particles and re-agglomerated using an appropriate carbonaceous binder such as petroleum pitch to form a “secondary particle”. The secondary particle graphite anode further protects graphite sheets from electrolyte decomposition and lithium plating particularly during long cycling and fast charging. The coating and binder themselves do not have lithium storage capacity but prevent degradation of graphite. The coating of graphite anode and formation of secondary particle require successive separate heat treatment at ˜1100-1300° C. adding to the overall production cost while resulting in lower yield.

While attempting to overcome these challenges with carbon-coated graphite anode, studies have been undertaken to develop graphite anode materials incorporating nucleating agents. Prior art looked at incorporating graphitization catalyst or nucleating agents on the surface of the graphite precursor to lower the graphitization temperature and improve the cycle life of graphite anode. Due to challenge with dispersing the graphitizing catalyst in the interior of the particle, the nucleating agents reacted with the carbon surface of the particles forming a carbide or nitride particle on the surface. The boron nitride formed is highly insulative which causes an increase in contact resistance and results in side reactions with lithium and electrolyte.

The present disclosure overcomes these challenges by the careful selection of graphitization catalyst that is incorporated in the interior of the graphite precursor and not just superficially on the surface. We also describe a method for incorporating the graphite catalyst within the precursor which is then graphitized at temperatures between 1800-3000° C. to produce a finished graphite anode with excellent discharge capacity, cycle life and rate capability.

### SUMMARY

In various aspects, the present disclosure provides composite powders comprising: about 0.1 wt. % to about 30 wt. % graphitization catalyst or a precursor thereof, based on a total mass of the composite powder; and about 20 wt. % to about 99.9 wt. % petroleum pitch, based on a total mass of the composite powder; wherein the graphitization catalyst or the precursor thereof is dispersed in a matrix comprising the petroleum pitch, and the petroleum pitch comprises a plurality of pitch particles.

In some or other various aspects, the present disclosure provides compositions comprising: up to about 35 wt. % graphitization catalyst dispersed in a carbon matrix, based on a total mass of the composition; wherein the carbon matrix comprises amorphous carbon.

In still other various aspects, methods of the present disclosure comprise: forming a blend comprising about 0.1 wt. % to about 35 wt. % graphitization catalyst or a precursor thereof and about 20 wt. % to about 99.9 wt. % petroleum pitch, each based on a total mass of the blend; and processing the blend under grinding conditions to form a composite powder; wherein the graphitization catalyst is dispersed in a matrix comprising the petroleum pitch and the petroleum pitch comprises a plurality of pitch particles.

Another objective of the present disclosure is to provide a negative electrode for lithium-ion battery which has a large discharge capacity, suffers surprisingly low loss in capacity during regular charging-discharging cycles and during charge-discharge at high rate.

In still other aspect, the disclosure provides a method of incorporating said graphitization catalyst within the graphite precursor via melt blending: 0.1 wt. % to about 35 wt. % graphitization catalyst or a precursor thereof and about 20 wt. % to about 99.9 wt. % petroleum pitch, each based on a total mass of the blend; and processing the produced composite under grinding conditions to form a composite powder; wherein the graphitization catalyst is dispersed within a matrix comprising the petroleum pitch and the petroleum pitch comprises a plurality of pitch particles. In some or other various aspects, the present disclosure relates to a negative electrode for metal ion battery having particle size in the range of 1 μm to 50 μm formed from a composite powder comprising 0.1 wt. % to 30 wt. % graphitizing catalyst or a precursor thereof, based on a total mass of the composite powder; and about 20 wt. % to about 99.9 wt. % petroleum pitch, based on a total mass of the composite powder; wherein the graphitization catalyst or the precursor thereof is dispersed in a matrix comprising the petroleum pitch, and the petroleum pitch comprises a plurality of pitch particles that has been graphitized at a temperature between 1800° C. to 3000° C.

In another embodiment, the graphitization catalyst is able to reduce the time required to achieve >90% degree of graphitization. The high rate of graphitization enables graphitization >80% at lower temperatures than standard ones (2800-3400° C.).

These and other features and attributes of the disclosed compositions and methods of the present disclosure and their advantageous applications and/or uses will be apparent from the detailed description which follows.

### BRIEF DESCRIPTION OF THE DRAWINGS

To assist one of ordinary skill in the relevant art in making and using the subject matter hereof, reference is made to the appended drawings. The following figures are included to illustrate certain aspects of the disclosure and should not be viewed as exclusive configurations. The subject matter disclosed is capable of considerable modifications, alterations, combinations, and equivalents in form and function, as will occur to those skilled in the art and having the benefit of this disclosure.

FIG. 1A is a diagram of a composite powder having a graphitization catalyst dispersed between pitch particles in accordance with some embodiments of the present disclosure.

FIG. 1B is a diagram of a composite powder having a graphitization catalyst within the interior of pitch particles in accordance with some embodiments of the present disclosure.

FIG. 1C is a diagram of a composite powder having a graphitization catalyst both within the interior of the pitch particles and dispersed between the pitch particles in accordance with some embodiments of the present disclosure.

FIG. 3 is an x-ray diffraction pattern for composite powders produced in accordance with some embodiments of the present disclosure.

FIG. 4 is a graph of degree of graphitization versus temperature for composite powders produced in accordance with some embodiments of the present disclosure.

FIG. 5 is a graph of capacity retention versus discharge cycles for electrodes produced in accordance with some embodiments of the present disclosure.

### DETAILED DESCRIPTION

The present disclosure relates to composite powders and, more particularly, to composite powders containing petroleum pitch or derived from petroleum pitch.

It is to be understood that the terms “pitch” and “petroleum pitch” are used interchangeably herein. Moreover, it is to be understood that the “pitch particles” described herein contain petroleum pitch.

As discussed above, graphite is a highly versatile material with a number of important uses due to its high electrical and thermal conductivity values, as well as its crystalline structure that may promote intercalation of lithium ions. Although graphite may be produced synthetically from inexpensive precursors, such as coke and petroleum pitch, processes for producing synthetic graphite are usually very energy intensive and lead to high production costs as a result. Additionally, synthetic pitch based graphite anodes are often limited in their ability to achieve high capacity, fast charging and cycle life.

The present disclosure employs a new approach to incorporate a graphitization catalyst or a precursor thereof to at least partially address the foregoing issue. A “graphitization catalyst” is a substance capable of promoting conversion of a precursor material into graphite under suitable pyrolysis conditions. Suitable graphitization catalysts may lower the temperature and/or the time required to produce synthetic graphite under the pyrolysis conditions or raise the amount of synthetic graphite produced under a given set of pyrolysis conditions. A precursor to a graphitization catalyst may be converted to the graphitization catalyst in the course of being heated under the pyrolysis conditions. Unless otherwise specified or evident from context in the present disclosure, the term “graphitization catalyst” is used herein to refer equivalently to a graphitization catalyst or a graphitization catalyst precursor.

More specifically, the present disclosure provides ready access to composite powders comprising a graphitization catalyst dispersed in petroleum pitch. Petroleum pitch is a carbon-rich viscoelastic material originating from petroleum and having properties similar to a thermoplastic polymer by virtue of having a softening temperature. Once produced, the composite powders may be readily shaped into a desired form before being converted into amorphous carbon and subsequently into graphite. Depending on whether the composite powders are formed above or below the softening temperature of the petroleum pitch, the dispersion of the graphitization catalyst within the petroleum pitch may differ. As explained in greater detail hereinafter, processing of the graphitization catalyst and the petroleum pitch below the softening temperature may lead to the graphitization catalyst being dispersed within an interstitial space around pitch particles (including contacting an outer surface of the pitch particles), whereas processing at or above the softening temperature may lead to dispersion of at least a portion of the graphitization catalyst within the interior of pitch particles following breakup of a continuous pitch matrix. Either composite powder morphology may be effective for promoting graphite production according to the disclosure herein, although composite powders having the graphitization catalyst dispersed within the interior of the pitch particles facilitate more effective contact with a larger surface area of the petroleum pitch to promote more effective conversion into graphite. Additionally, graphitization catalyst dispersed in the interior prevents the formation of nitrides and carbides that can potentially act as insulative material creating high resistance.

Grinding and/or pulverization processes (referred to as “grinding” or “grinding processes” hereinafter) may be utilized to facilitate production of the composite powders disclosed herein. Methods for forming the composite powders may include those employing continuous blending and grinding, either with or without first softening the petroleum pitch by heating above the softening temperature. The grinding processes may facilitate dispersion of the graphitization catalyst within the petroleum pitch. In addition, suitable grinding processes may promote conversion of larger pitch particles into a smaller size and/or promote conversion of a continuous pitch matrix into a particulate form. The graphitization catalyst may similarly undergo a reduction in size during the grinding process, possibly into a nanoparticle form. As used herein, the term “nanoparticle form” refers to any size range below about 1000 nm, preferably below about 500 nm, and more preferably below about 200 nm or below about 100 nm.

When the petroleum pitch is heated above its softening temperature during production of the composite powders according to the present disclosure, the blending processes herein may be referred to as melt blending processes. Conversely, when the petroleum pitch remains below its softening temperature during production of the composite powders, the blending processes herein may be referred to as dry blending processes. In the cases of both melt blending and dry blending processes, the blending process may be conducted continuously in a screw mill extruder or similar extruder type, and the resulting composite powder may be obtained directly from the extruder without the need for further grinding in most cases. Optionally, the composite powder may be sieved to a specified particle size, if needed or desired. Further optionally, dry blending processes may be conducted with the extruder being cooled (e.g., between about −10° C. to about 5° C.) to maintain the petroleum pitch in a hardened state and to limit potential chemical degradation. In the present disclosure, the term “cold blending” is used to refer to dry blending processes taking place below room temperature (23° C.) and below a softening temperature of the petroleum pitch undergoing blending.

A wide variety of graphitization catalysts may be suitable for use in the disclosure herein. In non-limiting examples, suitable graphitization catalysts may promote graphitization through mechanisms including, but not limited to, diffusion and intercalation, carbon dissolution-precipitation, carbide formation-decomposition, or any combination thereof. Multiple mechanisms for promoting graphite formation may be operative simultaneously, either with a single graphitization catalyst promoting graphitization by multiple mechanisms or by utilizing two or more graphitization catalysts that promote graphite formation through different mechanisms. Additional description of suitable graphitization catalysts is provided in greater detail below.

For the purposes of the present disclosure, the new numbering scheme for groups of the Periodic Table is used. In said numbering scheme, the groups (columns) are numbered sequentially from left to right from 1 through 18, excluding the f-block elements (lanthanides and actinides). Under this scheme, the term “transition metal” refers to any atom from Groups 3-12 of the Periodic Table.

Accordingly, composite powders of the present disclosure may comprise a graphitization catalyst or a graphitization catalyst precursor blended with petroleum pitch, wherein the graphitization catalyst or the graphitization catalyst precursor is dispersed in a matrix comprising the petroleum pitch, and the petroleum pitch comprises a plurality of pitch particles. In more specific examples, the composite powders may comprise about 0.1 wt. % to about 30 wt. % graphitization catalyst or a precursor thereof, based on total mass of the composite powder, and about 20 wt. % to about 99.9 wt. % petroleum pitch, based on total mass of the composite powder.

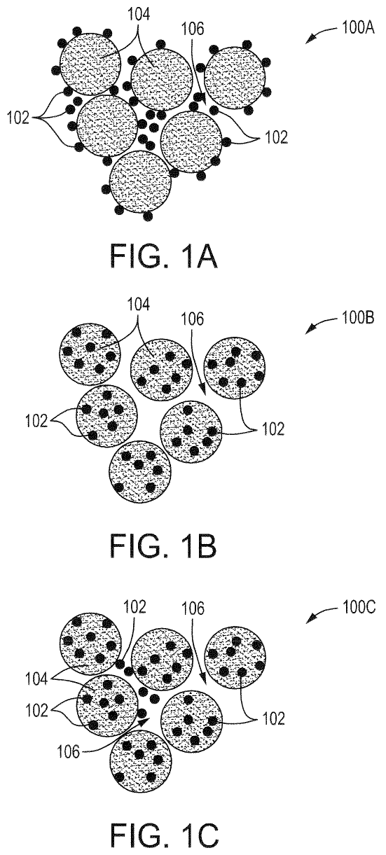

As referenced above, the morphology of the composite powders may vary depending on whether the graphitization catalyst is combined with the petroleum pitch under melt blending conditions, dry blending conditions, or a combination thereof. In dry blending processes, the graphitization catalyst may be dispersed in the composite powder by being located between pitch particles, such as in the interstitial space between the pitch particles, such that the graphitization catalyst contacts an outer surface of the pitch particles. FIG. 1A is a diagram of composite powder 100A showing graphitization catalyst 102 dispersed between pitch particles 104 within interstitial spaces 106 and/or situated upon the outer surface of pitch particles 104. Melt blending processes, in contrast, may produce the composite powder with at least a portion of the graphitization catalyst dispersed within the interior of the pitch particles, optionally with some of the graphitization catalyst being exposed to the surface of the pitch particles. FIG. 1B is a diagram of composite powder 100B showing graphitization catalyst 102 within the interior of pitch particles 104, in which case interstitial spaces 106 are unoccupied (as depicted in FIG. 1B) or some graphitization catalyst 102 may reside in interstitial spaces 106 and/or become embedded in the outer surface of pitch particles 104 (FIG. 1C). Optionally, further dry blending of composite powder 100B with a second portion of graphitization catalyst 102 may take place to fill at least a portion of interstitial spaces 106 with graphitization catalyst (additional filling not shown in FIG. 1). FIG. 1C is a diagram of composite powder 100C showing graphitization catalyst 102 within the interior of pitch particles 104 and also within interstitial spaces 106, wherein interstitial spaces 106 are filled either during a melt blending process or during a further dry blending process following a melt blending process. While pitch particles 104 and graphitization catalyst 102 are shown in FIGS. 1A-1C as being round and individually of the same size, it is to be appreciated that the particle shapes may be irregular and a range of particle sizes may be present for both graphitization catalyst 102 and pitch particles 104.

More specifically, composite powders of the present disclosure may comprise up to about 10 wt. %, or up to about 15 wt. %, or up to about 20 wt. %, or up to about 25 wt. %, or up to about 30 wt. % graphitization catalyst, and about 20 wt. % to about 99.9 wt. % petroleum pitch, each based on a total mass of the composite powder, and wherein the graphitization catalyst is dispersed in a matrix comprising the petroleum pitch, and the petroleum pitch comprises a plurality of pitch particles. In non-limiting examples, the composite powders may contain the graphitization catalyst or a precursor thereof in an amount ranging from about 0.1 wt. % to about 15 wt. %, or about 0.1 wt. % to about 15 wt. %, or about 0.1 wt. % to about 5 wt. %, or about 1 wt. % to about 15 wt. %, or about 1 wt. % to about 10 wt. %, or about 1 wt. % to about 5 wt. %, or about 2 wt. % to about 30 wt. %, or about 3 wt. % to about 25 wt. %, or about 3 wt. % to about 20 wt. %, or about 4 wt. % to about 20 wt. %, or about 5 wt. % to about 15 wt. %, or about 10 wt. % to about 20 wt. %, or about 3 wt. % to about 10 wt. %, each based on a total mass of the composite powders. In some or other non-limiting examples, the composite powders may contain the petroleum pitch in an amount ranging from about 25 wt. % to about 99.9 wt. %, or about 30 wt. % to about 80 wt. %, or about 40 wt. % to about 75 wt. %, or about 30 wt. % to about 50 wt. %, or about 50 wt. % to about 70 wt. %, or about 70 wt. % to about 90 wt. %, or about 80 wt. % to about 98 wt. %, or about 85 wt. % to about 99 wt. %, or about 90 wt. % to about 99.9 wt. %, each based on a total mass of the composite powders.

The petroleum pitch used in the present disclosure may be obtained from any source or process, provided that the petroleum pitch does not contain components that might be detrimental to an intended application following carbonization or graphitization of the composite powder. In some examples, at least a majority of the petroleum pitch may comprise a mesophase pitch. Mesophase pitch is an anisotropic pitch that comprises a complex mixture of aromatic molecules that are at least partially ordered and coalesce into a liquid crystalline phase. The crystallinity may enhance mechanical integrity, for example. Moreover, once carbonized and converted to graphite, the highly aligned structure may promote enhanced electrical conductivity, as well as facilitate production of the regular lattice structure of the graphite itself. In non-limiting examples, the petroleum pitch used herein may have a mesophase pitch content of about 50 wt. % or greater, or about 60 wt. % or greater, or about 70 wt. % or greater, or about 80 wt. % or greater, or about 90 wt. % or greater, or about 95 wt. % or greater, or about 99 wt. % or greater, or about 99.9 wt. % or greater, such as about 80 wt. % to about 99.9 wt. %, or about 90 wt. % to about 99.9 wt. %, or about 95 wt. % to about 99.9 wt. %, or even 100 wt. %, each based on a total mass of the petroleum pitch.

Suitable graphitization catalysts may promote conversion of petroleum pitch to graphite by one or more mechanisms including, but not limited to, diffusion and intercalation, carbon dissolution-precipitation, carbide formation-decomposition, or any combination thereof. A graphitization catalyst may be dispersed directly in a matrix comprising pitch particles, or a precursor to a graphitization catalyst may be utilized. Graphitization catalyst precursors may undergo a chemical reaction, including decomposition, to produce an active graphitization catalyst in the course of being heated up to a desired carbonization temperature and/or a desired graphitization temperature. Suitable graphitization catalysts may lower the temperature needed to convert amorphous carbon into graphite, decrease the amount of time needed to convert amorphous carbon into graphite, increase the amount of amorphous carbon converted into graphite, or any combination thereof, any or all of which may facilitate graphite production with a decreased energy consumption relative to conversion of petroleum pitch into graphite under un-catalyzed conditions. Moreover, having a larger portion of the graphitization catalysts inside the pitch matrix can further facilitate graphite production while minimizing energy consumption and resistance compared to having the catalyst on the pitch surface due to enhanced dispersion quality and limited nitride and carbide formation.

In some examples, suitable graphitization catalysts may promote graphitization by virtue of the diffusion constant of one or more elements therein. Without being bound by theory or mechanism, an element with a diffusion constant larger than carbon in both the transverse and longitudinal directions may enhance graphitization of petroleum pitch and similar graphite precursors by becoming intercalated between aromatic rings in adjacent layers, thereby leaving large voids that carbon may exploit through self-diffusion to improve the graphitization rate. Suitable graphitization catalysts that may promote graphitization through intercalation and diffusion include those containing a Group 13 element. Group 13 elements include boron, aluminum, gallium, indium, and thallium. In preferred examples, suitable graphitization catalysts containing a Group 13 element may comprise boron. Suitable boron-containing graphitization catalysts may include, but are not limited to, boric acid, organic esters of boric acid, sodium tetraborate, tetrahydroxyborate salts, orthoborate salts, metaborate salts, triborate salts, tetraborate salts, pentaborate salts, octaborate salts, boronic acids, boronate esters, boron oxides, boron carbides, the like, or any combination thereof.

In some examples, suitable graphitization catalysts may promote graphitization by a dissolution-precipitation mechanism (i.e., a carbon dissolution-precipitation mechanism). Without being bound by theory or mechanism, graphitization catalysts promoting graphitization by dissolution-precipitation may dissolve carbon (e.g., amorphous carbon) and then re-precipitate the dissolved carbon in ordered graphitic layers. Suitable graphitization catalysts that may promote graphitization through dissolution and precipitation include those containing a Group 8-10 element. Group 8-10 elements include iron, cobalt, nickel, ruthenium, rhodium, palladium, osmium, iridium, and platinum. In preferred examples, suitable graphitization catalysts containing a Group 8-10 element may comprise iron, cobalt, or nickel. Suitable graphitization catalysts containing a Group 8-10 element may include, but are not limited to, Fe₂O₃, Fe₃O₄, Fe metal, Co metal, Ni metal, Fe—Ni alloys, Co—Ni alloys, Fe—Co alloys, Ni—Co alloys, iron carbides, the like, or any combination thereof.

In some examples, suitable graphitization catalysts may promote graphitization by a carbide formation-decomposition mechanism. Without being bound by theory or mechanism, graphitization catalysts promoting graphitization by carbide formation-decomposition may form an initial metal carbide reaction product that subsequently decomposes to produce graphite and free metal. Suitable graphitization catalysts that may promote graphitization through carbide formation include those containing a Group 4-7 element. Group 4-7 elements include titanium, vanadium, chromium, manganese, zirconium, niobium, molybdenum, hafnium, tantalum, tungsten, and rhenium. In preferred examples, suitable graphitization catalysts containing a Group 4-7 element may comprise titanium, vanadium, chromium, or manganese. Suitable graphitization catalysts containing a Group 4-7 element may include, but are not limited to, Ti metal, V metal, Cr metal, Mn metal, titanium oxide, vanadium oxide, chromium oxide, manganese dioxide, and the like.

Additional graphitization catalysts that may be suitable for use herein include, for example, Group 2 elements such as beryllium, calcium, magnesium, strontium, and barium; Group 11 elements such as copper, silver and gold; Group 12 elements such as zinc; and Group 14 elements such as silicon.

Accordingly, the graphitization catalyst or the precursor thereof may comprise a compound containing at least one of a Group 2 element, a Group 4 element, a Group 5 element, a Group 6 element, a Group 7 element, a Group 8 element, a Group 9 element, a Group 10 element, a Group 13 element, Cu, Zn, or Si. Suitable compounds containing an element from the foregoing groups of the Periodic Table include, but are not limited to, oxides, carbides, salts, coordination compounds, and any combination thereof.

Once blended with the petroleum pitch, the graphitization catalyst may have any suitable size and any suitable particle size distribution to provide sufficient contact with the pitch matrix to promote graphitization thereof following carbonization. For example, the graphitization catalyst blended with the petroleum pitch may have a D50 of about 200 nm or less, or about 300 nm or less, or about 500 nm or less, and a D90 of about 1000 nm or less, or about 1200 nm or less, or about 1500 nm or less. As used herein, the term “D50” refers to a diameter at which 50% of a sample on a volume basis is comprised of particles having a diameter less than said diameter. As used herein, the term “D90” refers to a diameter at which 90% of a sample on a volume basis is comprised of particles having a diameter less than said diameter. Example particle size distributions of the graphitization catalyst used herein may include a D50 of about 10 nm to about 300 nm, or about 50 nm to about 250 nm, or about 100 nm to about 200 nm, or about 1 nm to about 200 nm, and/or a D90 of about 10 nm to about 1200 nm, or about 10 nm to about 1000 nm, or about 10 nm to about 900 nm, or about 700 nm to about 1100 nm.

In some or other examples, at least a majority, and preferably 75% or more or even 90% or more, of the graphitization catalyst present within the composite powders may have a size ranging from about 25 nm to about 200 nm, or about 50 nm to about 150 nm, or about 50 nm to about 100 nm, or about 50 nm to about 75 nm, or about 75 nm to about 100 nm, or about 75 nm to about 125 nm, or about 125 nm to about 175 nm. It should be noted that graphitization catalysts having a particle size larger than the foregoing may be used to produce the composite powders disclosed herein, since the graphitization catalyst may undergo a reduction in particle size under the grinding processes used to produce the composite powders according to the further description herein. For example, the graphitization catalysts may have a size up to about 500 nm, or up to about 1 micron, or up to about 5 microns, or up to about 10 microns before undergoing a reduction in particle size when processing a blend of the petroleum pitch and the graphitization catalyst in a grinding process to produce the composite powders disclosed herein.

Similarly, the petroleum pitch may undergo a reduction in particle size when processing a blend of petroleum pitch and graphitization catalyst under suitable grinding conditions. Accordingly, the composite powders of the present disclosure may contain at least petroleum pitch particles having a particle size ranging from about 1 □m to about 50 □m, or about 5 □m to about 50 □m, or about 5 □m to about 25 □m, or about 10 □m to about 30 □m. The particle sizes are measured by laser diffraction using a particle size analyzer via both dry and wet methods. Dry methods comprise of measuring the powder directly, whereas wet methods disperse the powders up to 5 wt. % in a solvent like mineral oil.

The composite powders of the present disclosure may optionally further comprise graphite, which may be introduced when blending the graphitization catalyst with the petroleum pitch and forming the composite powder, or the graphite may be mixed with the composite powder afterward. In non-limiting examples, the composite powders may comprise graphite in an amount ranging from about 0.1 wt. % to about 85 wt. %, or about 0.1 wt. % to about 60 wt. %, or about 5 wt. % to about 60 wt. %, or about 5 wt. % to about 20 wt. %, or about 20 wt. % to 40 wt. %, or about 30 wt. % to about 60 wt. %, or about 5 wt. % to about 20 wt. %, or about 20 wt. % to about 50 wt. %, each based on total mass of the composite powder. Like the graphitization catalyst, graphite, if present in the composite powders, may be present exterior to the pitch particles (e.g., within the interstitial spaces between pitch particles, including upon the outer surface of pitch particles), if the composite powder is prepared by a dry blending process, or within the interior of the pitch particles, if the composite powder is prepared by a melt blending process. In some examples, the added graphite present within the composite powders may be upgraded by having its graphitization percentage increased after the composite powders have been carbonized and subsequently graphitized in the presence of the graphitization catalyst. Without being limited by theory or mechanism, the graphitization catalyst may promote such upgrading of the added graphite.

Moreover, in some instances, the composite powders may be further processed after incorporating the graphitization catalyst (and optionally graphite) but before carbonizing and/or graphitizing the petroleum pitch within the composite powder. In particular, the composite powders may be heated in a low-oxygen environment (e.g., about 0.1 mol % oxygen to about 20 mol % oxygen) below the softening temperature of the petroleum pitch. At least some oxidation of the petroleum pitch may take place under such conditions to provide a number of benefits. Namely, when heating petroleum pitch in a low-oxygen environment below the softening temperature of the petroleum pitch, mechanical integrity of the composite powder and carbon matrices produced therefrom may be enhanced through at least partial crosslinking of the petroleum pitch. The at least partial crosslinking may increase the softening temperature of the petroleum pitch as well, thereby allowing the composite powder to maintain its shape more readily as the composite powder is heated up during carbonization or graphitization. Moreover, when at least a portion of the graphitization catalyst is located upon the outer surface of the pitch particles and/or within the interstitial spaces between pitch particles, the graphitization catalyst may become at least partially embedded in the outer surface of the pitch particles being processed under such conditions.

In non-limiting examples, the foregoing heating below the softening temperature may take place at a temperature above room temperature and below about 500° C., or below about 400° C., or below about 300° C., or below about 200° C., such as within a range of about 200° C. to about 450° C., or about 200° C. to about 300° C., or about 200° C. to about 250° C., or about 250° C. to about 350° C., or about 300° C. to about 450° C. The actual heating temperature may be selected based upon the initial softening temperature of the petroleum pitch. The low-oxygen environment may have an oxygen concentration from ranging from about 0.1 mol % to about 20 mol %, or about 1 mol % to about 15 mol %, or about 1 mol % to about 10 mol %, or about 1 mol % to about 5 mol %, or less than about 5 mol %, or less than about 1 mol %. Thus, in some examples, the composite powders may be heated at a temperature ranging from about 200° C. to about 450° C., or about 200° C. to about 300° C., or about 300° C. to about 450° C., or about 250° C. to about 400° C. in an environment containing about 0.1 mol % to about 20 mol % oxygen. When heated under the foregoing conditions, at least some crosslinking of the petroleum pitch may take place. A concurrent increase in softening temperature may occur upon crosslinking of the petroleum pitch.

The above composite powders may serve as a precursor composite for forming carbon composites in which the petroleum pitch is pyrolyzed (carbonized) to form a carbon matrix comprising amorphous carbon and/or graphite. Amorphous carbon may be distinguished from graphite spectroscopically by powder X-ray diffraction, for example. Conversion of the composite powders to a graphite-containing composite may occur with initial conversion of the petroleum pitch to amorphous carbon at a first heating temperature, followed by a subsequent heating operation at a second heating temperature that is higher than the first heating temperature to form graphite, each heating operation being conducted under conditions that may lead to a minimal reaction with oxygen. Amorphous carbon may be formed upon exposing the petroleum pitch to a temperature ranging from about 700° C. to about 1800° C., or about 900° C. to about 1800° C., preferably about 900° C. to about 1500° C. or about 1000° C. to about 1500° C., or more preferably about 900° C. to about 1400° C., in a no-oxygen or very low-oxygen environment (e.g., an oxygen content below about 0.1 mol % or below), preferably in the presence of an inert gas environment. Thus, in some examples, the composite powders may be at least partially carbonized at a carbonization temperature ranging from about 700° C. to about 1800° C. or about 900° C. to about 1500° C. in an environment comprising about 0.1 mol % oxygen or below, which may at least partially convert the petroleum pitch to amorphous carbon.

After converting the petroleum pitch to amorphous carbon, graphitization of the composite powders may then occur. Under un-catalyzed conditions, graphite may be formed from amorphous carbon by heating to a higher temperature ranging from about 2800° C. to about 3400° C., or about 2800° C. to about 3000° C. in a no-oxygen or very low-oxygen environment, preferably in the presence of an inert gas environment, over a time that may range up to about 24 hours, or up to about 48 hours, or even up to about 72 hours. By using a graphitization catalyst according to the disclosure herein, increased graphite yields may be realized at lower heating temperatures and/or over a shorter heating time.

In non-limiting examples, graphitization of the composite powders disclosed herein may take place at a graphitization temperature up to about 3400° C., such as a graphitization temperature ranging from about 2000° C. to about 3400° C., or about 2000° C. to about 2500° C., or about 2500° C. to about 3000° C., or about 2800° C. to about 3200° C., or about 2200° C. to about 2800° C., or even at a graphitization temperature lower than about 2000° C. but above the carbonization temperature. When utilizing a graphitization catalyst according to the disclosure herein, about 80 wt. % or more, or about 85 wt. % or more, or about 90 wt. % or more, or about 90 wt. % or more of the petroleum pitch in the composite powders may undergo conversion into graphite. Under the foregoing conditions, the time period over which graphitization is conducted may be about 18 hours or less, or about 15 hours or less, or about 12 hours or less, or about 10 hours or less, or about 9 hours or less, or about 8 hours or less, or about 7 hours or less, or about 6 hours or less, or about 5 hours or less, or about 4 hours or less, or about 3 hours or less, or about 2 hours or less, or about 1 hour or less. In some examples, graphitization may take place at a graphitization temperature of about 3000° C. to about 3400° C. but over a short graphitization time of about 1 hour or less, or about 50 minutes or less, or about 40 minutes or less, or about 30 minutes or less, or about 20 minutes or less, or about 10 minutes or less. Thus, in at least some examples, after at least partially carbonizing the composite powder, heating above a carbonization temperature may take place in a no-oxygen or very low-oxygen environment comprising 0.1 mol % oxygen or below to convert at least a portion of the amorphous carbon into graphite.

The compositions resulting from initial carbonization of the petroleum pitch to form amorphous carbon may be isolated and/or analyzed before subsequent conversion to graphite takes place. Such compositions may comprise up to about 35 wt. % graphitization catalyst dispersed in a carbon matrix, based on total mass of the composition, wherein the carbon matrix comprises at least amorphous carbon. Alternately, the compositions obtained following carbonization may be directly heated to a graphitization temperature without undergoing cooling following carbonization. That is, carbonization and graphitization of the composite powders may take place in a single heating operation in some instances.

Accordingly, such compositions may be produced by a process including heating the petroleum pitch to a carbonization temperature sufficient to form the carbon matrix in a no-oxygen or very low-oxygen environment comprising about 0.1 mol % oxygen or below, wherein the graphitization catalyst precursor, if present, is converted to the graphitization catalyst while forming the carbon matrix. The petroleum pitch or amorphous carbon may be further converted to graphite at a suitable graphitization temperature, as discussed further herein. In either case, heating may take place in an environment comprising about 0.1 mol % oxygen or below.

A small amount of mass loss may occur when carbonizing the composite powders to form the carbon matrix. Without being limited by theory or mechanism, the mass loss is believed to result from various reactions of the petroleum pitch that form gaseous products. Such reactions may include, for instance, dehydrogenation, polymerization with side chain loss and/or hydrogen production, dealkylation, condensation of aromatic rings, and decomposition of oxygen-containing groups. Gaseous products may include, for example, carbon monoxide, carbon dioxide, water vapor, hydrocarbon vapor, methane, and the like. Up to about 20 wt. % of the petroleum pitch may undergo mass loss due to oxidation during carbonization. Preferably, the amount of such mass loss is about 10 wt. % or less, or about 5 wt. % or less, or about 2 wt. % or less. With such mass loss occurring during carbonization, the corresponding loading of the graphitization catalyst in the carbon matrix may increase, such as up to about 35 wt. % based on total mass of the resulting carbon matrix.

Methods of the present disclosure may provide composite powders, compositions produced from the composite powders and containing a carbon matrix comprising amorphous carbon, or compositions produced from the composite powders comprising a carbon matrix comprising graphite. As referenced above, the composite powders may be produced under grinding conditions suitable to disperse the graphitization catalyst or a precursor thereof in a matrix comprising a petroleum pitch in the form of a plurality of pitch particles. Such methods may comprise: forming a blend comprising about 0.1 wt. % to about 30 wt. % graphitization catalyst or a precursor thereof and 20 wt. % to 99.9 wt. % petroleum pitch, each based on total mass of the blend; and processing the blend under grinding conditions to form a composite powder, in which the graphitization catalyst is dispersed in a matrix comprising the petroleum pitch, and the petroleum pitch comprises a plurality of pitch particles.

In some examples, the composite powders may be produced by dry blending processes. Suitable dry blending processes for making the composite powders described herein allow for single-step processing of materials to be realized, while ensuring appropriate particle sizes and a thorough dispersion of the graphitization catalyst among the pitch particles. Dry blending processes, preferably cold blending processes, may combine the graphitization catalyst and the petroleum pitch in a manner to maintain the petroleum pitch below its softening temperature while dispersing particles of the graphitization catalyst among a plurality of pitch particles. Combining the petroleum pitch and the graphitization catalyst in the foregoing manner may comprise milling, extruding, grinding, the like, or any combination thereof. A reduction in particle size of the petroleum pitch and/or the graphitization catalyst may take place in the course of such dry blending processes.

In non-limiting examples of suitable dry blending processes, the composite powders disclosed herein may be formed by milling or grinding a suitable petroleum pitch and a suitable graphitization catalyst, preferably during a continuous milling or grinding process, more preferably a milling or grinding process conducted in a screw mill extruder. Without being bound by theory, milling or grinding may suitably combine the graphitization catalyst and the petroleum pitch as particles into a well-dispersed state while concurrently reducing the particle size of the individual components (e.g., the graphitization catalyst and the petroleum pitch) within the composite powders. Thus, the graphitization catalyst and petroleum pitch introduced to the screw mill extruder need not necessarily reside within the final size range present in the composite powders. For example, the graphitization catalyst introduced to the screw mill extruder may be up to about 10 microns in size, or up to about 5 microns in size, or up to about 1 micron in size, or up to about 500 nm in size and undergo a reduction in size as blending takes place. The screw mill may be any suitable size and configuration for achieving a desired extent of dispersion of the graphitization catalyst within the petroleum pitch and for achieving a desired particle size. It is to be appreciated that the composite powders may also be produced in related grinding processes that are non-continuous (batch) processes, such as ball milling.

In some examples and preferably, the composite powders may be produced by melt blending processes, in which the graphitization catalyst may be blended with the petroleum pitch at or above a softening temperature of the petroleum pitch. In non-limiting examples, the heating during a melt blending process may take place at a temperature above the softening temperature and up to about 500° C., or up to about 400° C., or up to about 350° C., or up to about 325° C., such as within a range of about 300° C. to about 500° C., or about 325° C. to about 450° C., or about 350° C. to about 425° C., or about 350° C. to about 475° C. In so processing the graphitization catalyst with the petroleum pitch, at least a portion of the graphitization catalyst may become dispersed within a continuous pitch matrix that comprises softened petroleum pitch. As with dry blending processes, the graphitization catalyst may undergo a change in particle size as blending with the petroleum pitch occurs. Once a desired degree of blending has taken place to disperse the graphitization catalyst within the petroleum pitch, the resulting melt blend containing the continuous pitch matrix may be cooled to a temperature below the softening temperature, at which point the continuous pitch matrix may be broken up into a plurality of pitch particles containing the graphitization catalyst within the interior of the pitch particles.

Suitable melt blending processes may be conducted in an extruder in a similar manner to related dry blending processes, except for initially heating above the softening temperature of the petroleum pitch, followed by cooling below the softening temperature once the graphitization catalyst has been thoroughly dispersed within the continuous pitch matrix. Heating may be conducted in a multi-zone extruder having a first zone maintained at a temperature above the softening temperature of the petroleum pitch and a second zone maintained at a temperature below the softening temperature of the petroleum pitch. Such melt blending processes may likewise be performed in a screw mill extruder under continuous grinding conditions, or alternately batchwise using ball or sand milling above the softening temperature of the petroleum pitch, followed by cooling and grinding the continuous pitch matrix thereafter to form the composite powder.

It is to be appreciated that combination grinding processes are also contemplated in the present disclosure. For example, two or more extruders in series may be utilized to achieve a desired particle size or extent of blending and/or two or more extruders in parallel may be utilized to increase throughput. In another example, two or more extruders in series may be utilized at different temperatures, wherein a first extruder forms a continuous pitch matrix containing dispersed graphitization catalyst above the softening temperature of the petroleum pitch and a second extruder grinds the continuous pitch matrix into a composite powder below the softening temperature of the petroleum pitch. Moreover, it is to be appreciated that a melt blending process achieves a higher quality of dispersion by having more of the graphitization catalysts in the interior of the pitch particles. In still other examples, a dry blending process may follow a melt blending process to produce composite powders having graphitization catalyst dispersed both within the interior of the pitch particles and between the pitch particles.

After processing to the right particle size distribution and at the right temperatures, the composite electrode powders are added into a water solution at up to 97 wt % solids loading. Additional conductive additives and binders are added at up to 10 wt % loadings. The solutions are then mixed to achieve a good dispersion. The resulting slurries are coated onto a copper foil that is the current collector, dried into films, and calendered to achieve a total film thickness of up to 150 μm with up to 15 layers making the negative electrode (i.e. anode). The anode electrode sheets are added to cathode ones with a separator film in between and pressed together into a pouch cell. Finally, the resulting cell is filled with an electrolyte made from a combination of carbonates (ethyl, ethyl methyl, dimethyl, etc. . . . ) and lithium salts (LiPO₂F₂, LiBF₄, LiBOB, LiPF₆, LiFSI, LiTFSI, etc. . . . ).

Embodiments disclosed herein include:
A. Composite powders. The composite powders comprise: about 0.1 wt. % to about 30 wt. % graphitization catalyst or a precursor thereof, based on a total mass of the composite powder; and about 20 wt. % to 99.9 wt. % petroleum pitch, based on a total mass of the composite powder; wherein the graphitization catalyst or the precursor thereof is dispersed in a matrix comprising the petroleum pitch, and the petroleum pitch comprises a plurality of pitch particles.
B. Compositions obtained from composite powders. The compositions comprise: up to about 35 wt. % graphitization catalyst dispersed in a carbon matrix, based on a total mass of the composition; wherein the carbon matrix comprises amorphous carbon.
B1. The composition of B, wherein the composition is produced by a process comprising providing the composite powder of A; and heating the petroleum pitch at a carbonization temperature sufficient to form the carbon matrix in an environment comprising about 0.1 mol % oxygen or below; wherein the graphitization catalyst precursor, if present, is converted to the graphitization catalyst while forming the carbon matrix.
C. Methods for making composite powders. The methods comprise: forming a blend comprising about 0.1 wt. % to about 35 wt. % graphitization catalyst or a precursor thereof and about 20 wt. % to about 99.9 wt. % petroleum pitch, each based on a total mass of the blend; and processing the blend under grinding conditions to form a composite powder; wherein the graphitization catalyst is dispersed in a matrix comprising the petroleum pitch and the petroleum pitch comprises a plurality of pitch particles.

Embodiments A-C may have one or more of the following additional elements in any combination:
Element 1: wherein the petroleum pitch comprises about 50 wt. % or greater mesophase pitch.
Element 2: wherein the graphitization catalyst or the precursor thereof is dispersed in an interstitial space between the pitch particles.
Element 3: wherein at least a portion of the graphitization catalyst or the precursor thereof is dispersed within an interior of the pitch particles.
Element 4: wherein the pitch particles have a particle size ranging from about 1 □m to about 25 □m.
Element 5: wherein the composite powder comprises about 0.1 wt. % to about 10 wt. % graphitization catalyst.
Element 6: wherein the graphitization catalyst or the precursor thereof comprises a compound containing at least one of a Group 2 element, a Group 4 element, a Group 5 element, a Group 6 element, a Group 7 element, a Group 8 element, a Group 9 element, a Group 10 element, a Group 13 element, Cu, Zn, or Si.
Element 7: wherein the graphitization catalyst or the precursor thereof comprises an oxide, a carbide, a salt, a coordination compound, or any combination thereof.
Element 8: wherein the graphitization catalyst or the precursor thereof comprises a boron-, iron-, nickel-, cobalt-, molybdenum-, titanium-, zirconium-, manganese-, and vanadium-containing compound.
Element 9: wherein the boron-containing compound comprises at least one compound selected from the group consisting of boric acid, sodium tetraborate, tetrahydroxyborate salts, orthoborate salts, metaborate salts, triborate salts, tetraborate salts, pentaborate salts, octaborate salts, boronic acids, boronate esters, boron oxides, boron carbides, and combinations thereof.
Element 10: wherein the carbonization temperature ranges from about 700° C. to about 1800° C.
Element 11: wherein forming the blend comprises melt blending the graphitization catalyst or the precursor thereof and the petroleum pitch at or above a softening temperature of the petroleum pitch to disperse the graphitization catalyst or the precursor thereof in a continuous pitch matrix, and processing the blend under the grinding conditions comprises grinding the continuous pitch matrix to form the pitch particles with at least a portion of the graphitization catalyst or the precursor thereof dispersed within an interior of the pitch particles.
Element 12: wherein the method further comprises heating the composite powder at a temperature ranging from about 200° C. to about 450° C. in an environment containing about 0.1 mol % to about 20 mol % oxygen.
Element 13: wherein the method further comprises at least partially carbonizing the composite powder at a carbonization temperature ranging from about 700° C. to about 1800° C. in an environment comprising about 0.1 mol % oxygen or below to at least partially convert the petroleum pitch to amorphous carbon.
Element 14: wherein the method further comprises after at least partially carbonizing the composite powder, heating at a graphitization temperature above the carbonization temperature in an environment comprising about 0.1 mol % oxygen or below to convert at least a portion of the amorphous carbon into graphite.
Element 15: wherein about 80 wt. % or more of the petroleum pitch in the composite powder is converted to graphite.
Element 16: wherein the graphitization temperature ranges from about 2000° C. to about 3400° C.
Element 17: wherein heating at the graphitization temperature takes place for about 0.1 hour to about 5 hours.

By way of non-limiting example, exemplary combinations applicable to A-C include, but are not limited to, 1 and 2; 1 and 3; 1-3; 1 and 4; 1 and 5; 1 and 6; 1 and 7; 1, 7, and 8; 1 and 11; 1 and 12; 1, 11, and 12; 1 and 13; 1, 11, and 13; 1 and 11-13; 1 and 14; 1 and 11-14; 1, 11, 13, and 14; 2 and/or 3, and 4; 2 and/or 3, and 5; 2 and/or 3, and 6; 2 and/or 3, and 7; 2 and/or 3, 7, and 8; 2 and/or 3, and 11; 2 and/or 3, and 12; 2 and/or 3, 11, and 12; 2 and/or 3, and 13; 2 and/or 3, 11, and 13; 2 and/or 3, and 11-13; 2 and/or 3, and 14; 2 and/or 3, and 11-14; 2 and/or 3, 11, and 13; 2 and/or 3, 11, 13, and 14; 4 and 5; 4 and 6; 4 and 7; 4, 7, and 8; 4 and 11; 4 and 12; 4, 11, and 12; 4 and 13; 4, 11, and 13; 4 and 11-13; 4 and 14; 4 and 11-14; 4, 11, and 13; 4, 11, 13, and 14; 5 and 6; 5 and 7; 5, 7, and 8; 5 and 11; 5 and 12; 5, 11, and 12; 5 and 13; 5 and 11-13; 5 and 14; 5 and 11-14; 5, 11, and 13; 5, 11, 13, and 14; 6 and 7; 6-8; 6 and 11; 6 and 12; 6, 11, and 12; 6 and 13; 6 and 11-13; 6 and 14; 6 and 11-14; 6, 11, and 13; 6, 11, 13, and 14; 7 and 8; 7 and 11; 7 and 12; 7, 11, and 12; 7 and 13; 7, 11, and 13; 7 and 11-13; 7 and 14; 7 and 11-14; 7, 11, 13, and 14; 8 and 11; 8 and 12; 8, 11, and 12; 8 and 13; 8, 11, and 13; 8 and 11-13; 8 and 14; 8 and 11-14; 8, 11, 13, and 14; 12 and 13; 12-14; 12 and 14; 12-15; 12-16; 13 and 14; 13-15; 13-16; 13-17; 14 and 15; 14 and 16; 14-16; and 14-17.

Additional embodiments disclosed herein include:
Embodiment 1. A composite powder comprising:
about 0.1 wt. % to about 30 wt. % graphitization catalyst or a precursor thereof, based on a total mass of the composite powder; and
about 20 wt. % to 99.9 wt. % petroleum pitch, based on a total mass of the composite powder;
   wherein the graphitization catalyst or the precursor thereof is dispersed in a matrix comprising the petroleum pitch, and the petroleum pitch comprises a plurality of pitch particles.
Embodiment 2. The composite powder of embodiment 1, wherein the petroleum pitch comprises about 50 wt. % or greater mesophase pitch.
Embodiment 3. The composite powder of embodiment 1 or embodiment 2, wherein the graphitization catalyst or the precursor thereof is dispersed in an interstitial space between the pitch particles.
Embodiment 4. The composite powder of embodiment 1 or embodiment 2, wherein at least a portion of the graphitization catalyst or the precursor thereof is dispersed within an interior of the pitch particles.
Embodiment 5. The composite powder of any one of embodiments 1-4, wherein the pitch particles have a particle size ranging from about 1 □m to about 25 □m.
Embodiment 6. The composite powder of any one of embodiments 1-5, wherein the composite powder comprises about 0.1 wt. % to about 10 wt. % graphitization catalyst.
Embodiment 7. The composite powder of any one of embodiments 1-6, wherein the graphitization catalyst or the precursor thereof comprises a compound containing at least one of a Group 2 element, a Group 4 element, a Group 5 element, a Group 6 element, a Group 7 element, a Group 8 element, a Group 9 element, a Group 10 element, a Group 13 element, Cu, Zn, or Si.
Embodiment 8. The composite powder of any one of embodiments 1-7, wherein the graphitization catalyst or the precursor thereof comprises an oxide, a carbide, a salt, a coordination compound, or any combination thereof.
Embodiment 9. The composite powder of any one of embodiments 1-8, wherein the graphitization catalyst or the precursor thereof comprises a boron-, iron-, nickel-, cobalt-, molybdenum-, titanium-, zirconium-, manganese-, and vanadium-containing compound.
Embodiment 10. The composite powder of embodiment 9, wherein the boron-containing compound comprises at least one compound selected from the group consisting of boric acid, sodium tetraborate, tetrahydroxyborate salts, orthoborate salts, metaborate salts, triborate salts, tetraborate salts, pentaborate salts, octaborate salts, boronic acids, boronate esters, boron oxides, boron carbides, and combinations thereof.
Embodiment 11. A composition comprising: up to about 35 wt. % graphitization catalyst dispersed in a carbon matrix, based on a total mass of the composition; wherein the carbon matrix comprises amorphous carbon.
Embodiment 12. The composition of embodiment 11, wherein the composition is produced by a process comprising: providing the composite powder of any one of embodiments 1-10; and heating the petroleum pitch at a carbonization temperature sufficient to form the carbon matrix in an environment comprising about 0.1 mol % oxygen or below; wherein the graphitization catalyst precursor, if present, is converted to the graphitization catalyst while forming the carbon matrix.
Embodiment 13. The composition of embodiment 12, wherein the carbonization temperature ranges from about 700° C. to about 1800° C.
Embodiment 14. A method comprising: forming a blend comprising about 0.1 wt. % to about 35 wt. % graphitization catalyst or a precursor thereof and about 20 wt. % to about 99.9 wt. % petroleum pitch, each based on a total mass of the blend; and processing the blend under grinding conditions to form a composite powder; wherein the graphitization catalyst is dispersed in a matrix comprising the petroleum pitch and the petroleum pitch comprises a plurality of pitch particles.
Embodiment 15. The method of embodiment 14, wherein forming the blend comprises melt blending the graphitization catalyst or the precursor thereof and the petroleum pitch at or above a softening temperature of the petroleum pitch to disperse the graphitization catalyst or the precursor thereof in a continuous pitch matrix, and processing the blend under the grinding conditions comprises grinding the continuous pitch matrix to form the pitch particles with at least a portion of the graphitization catalyst or the precursor thereof dispersed within an interior of the pitch particles.
Embodiment 16. The method of embodiment 14 or embodiment 15, wherein the petroleum pitch comprises about 50 wt. % or greater mesophase pitch.
Embodiment 17. The method of any one of embodiments 14-16, wherein the pitch particles have a particle size ranging from about 1 □m to about 25 □m.
Embodiment 18. The method of any one of embodiments 14-17, wherein the composite powder comprises about 0.1 wt. % to about 10 wt. % graphitization catalyst or the precursor thereof.
Embodiment 19. The method of any one of embodiments 14-18, wherein the graphitization catalyst or the precursor thereof comprises a compound containing at least one of a Group 2 element, a Group 4 element, a Group 5 element, a Group 6 element, a Group 7 element, a Group 8 element, a Group 9 element, a Group 10 element, a Group 13 element, Cu, Zn, or Si.
Embodiment 20. The method of any one of embodiments 14-19, wherein the graphitization catalyst or the precursor thereof comprises an oxide, a carbide, a salt, a coordination compound, or any combination thereof.
Embodiment 21. The method of any one of embodiments 14-20, wherein the graphitization catalyst or the precursor thereof comprises a boron-, iron-, nickel-, cobalt-, molybdenum-, titanium-, zirconium-, manganese-, and vanadium-containing compound.
Embodiment 22. The method of embodiment 21, wherein the boron-containing compound comprises at least one compound selected from the group consisting of boric acid, sodium tetraborate, tetrahydroxyborate salts, orthoborate salts, metaborate salts, triborate salts, tetraborate salts, pentaborate salts, octaborate salts, boronic acids, boronate esters, boron oxides, boron carbides, the like, or any combination thereof.
Embodiment 23. The method of any one of embodiments 14-22, further comprising: heating the composite powder at a temperature ranging from about 200° C. to about 450° C. in an environment containing about 0.1 mol % to about 20 mol % oxygen.
Embodiment 24. The method of any one of embodiments 14-23, further comprising: at least partially carbonizing the composite powder at a carbonization temperature ranging from about 700° C. to about 1800° C. in an environment comprising about 0.1 mol % oxygen or below to at least partially convert the petroleum pitch to amorphous carbon.
Embodiment 25. The method of embodiment 24, further comprising: after at least partially carbonizing the composite powder, heating at a graphitization temperature above the carbonization temperature in an environment comprising about 0.1 mol % oxygen or below to convert at least a portion of the amorphous carbon into graphite.
Embodiment 26. The method of embodiment 25, wherein about 80 wt. % or more of the petroleum pitch in the composite powder is converted to graphite.
Embodiment 27. The method of embodiment 25 or embodiment 26, wherein the graphitization temperature ranges from about 1800° C. to about 3400° C.
Embodiment 28. The method of any one of embodiments 25-27, wherein heating at the graphitization temperature takes place for about 0.1 hour to about 5 hours.

To facilitate a better understanding of the embodiments of the present disclosure, the following examples of preferred or representative embodiments are given. In no way should the following examples be read to limit, or to define, the scope of the invention.

### EXAMPLES

Composite powder samples were prepared by blending neat petroleum pitch and iron (E2), iron oxide (E2), boric acid (E1), ferrocene (E2), titanium carbide (E3), boron carbide (E1), zirconium carbide (E4), manganese (E5), boron (E1), nickel (E6), cobalt (E7), molybdenum (E8), and vanadium (E9). together under melt blending conditions in an extruder set at a rotation rate of 280 rpm and established at a set point temperature above 280° C. The throughput of the resulting melt blend was 300 g/hr. After dispersion of the catalysts in the continuous pitch matrix, the temperature was lowered to room temperature, and the continuous pitch matrix was batchwise ground into pitch particles having the boric acid internally contained therein. After obtaining the resulting composite powders, the samples were placed inside a furnace and further heated below the softening point of the petroleum pitch at a temperature between 200° C. and 300° C. to at least partially react oxygen with the petroleum pitch.

Composite powders containing various graphitization catalysts were first heated at 1100° C. for 10 hour in a nitrogen atmosphere to convert the pitch into amorphous carbon, followed by heating at 1300-3000° C. for 8 hours in an argon atmosphere. The extent of graphitization was determined as described further below as a function of the loading of the graphitization catalyst. The extent of graphitization was estimated by powder X-ray diffraction (XRD), and results are summarized in Tables 1, 2, and 3 for each catalyst Interplanar d-spacing values (d₀₀₂) calculated from powder X-ray diffraction are also provided in Table 1.

TABLE 1

| Sample | Carbon | Catalyst | | Graphitization |
|---|---|---|---|---|
| ID | Source | Loading (Wt. %) | d₀₀₂ (nm) | @ 2200° C. (%) |
| C1 | Pitch | 0 | 0.3380 | 69.8 |
| C2 | Needle Coke | 0 | 0.3379 | 70.9 |
| E1 | Pitch | 2 | 0.3361 | 91.9 |
| E2 | Pitch | 2 | 0.3370 | 81.2 |
| E3 | Pitch | 2 | 0.3372 | 78.6 |
| E4 | Pitch | 2 | 0.3371 | 79.9 |
| E5 | Pitch | 2 | 0.3377 | 73.3 |
| E6 | Pitch | 2 | 0.3371 | 80.8 |
| E7 | Pitch | 2 | 0.3371 | 80.1 |
| E8 | Pitch | 2 | 0.3376 | 75.0 |
| E9 | Pitch | 2 | 0.3374 | 77.0 |

As shown in Table 1, there was an increase in the degree of graphitization at a catalyst loading of 2 wt. % (Samples E1-9). The extent of increase in the degree of graphitization varied between the different catalysts ranging between 5% and up to 22%.

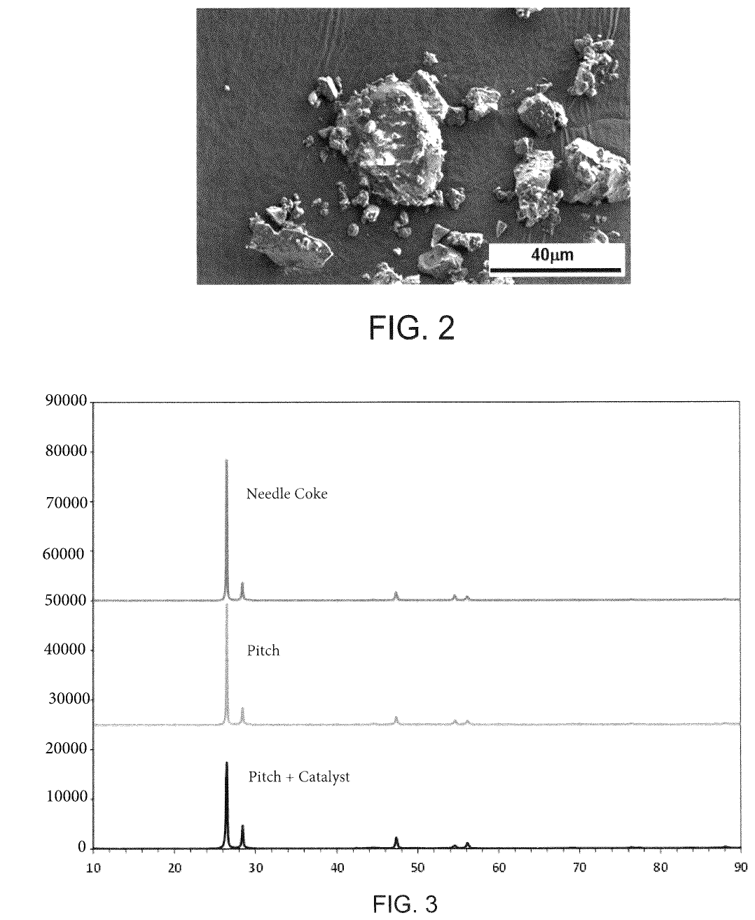

To determine the d-spacing values in Table 1, the powder XRD pattern of each sample was obtained, and the 002-peak of graphite was further analyzed. Powder XRD was performed using Cu K-□ radiation having a wavelength of 1.5406 Å. The 002-peak of graphite is located at a 2θ value of approximately 26°, where θ is the X-ray scattering angle. As an example, FIG. 3 is a powder XRD pattern of the 002-peak of graphite for Samples C1, C2, and E1. Based on the 2θ peak position of the 002-peak, the Bragg equation (Equation 1) was used to calculate the interplanar d-spacing values (d₀₀₂). From the d₀₀₂ value, the extent of graphitization (G) was calculated using the Mering and Maire equation (Equation 2). The extent of graphitization (G) is further provided in Table 2. In Equations 1 and 2, □ is the X-ray wavelength, and the other variables are defined as above.

$$□ = 2 {d}_{002} \times sin θ \qquad ( Equation 1 )$$

$$G = ( 0.344 - {d}_{002} / ( 0.344 - 0.3354 ) \qquad ( Equation 2 )$$

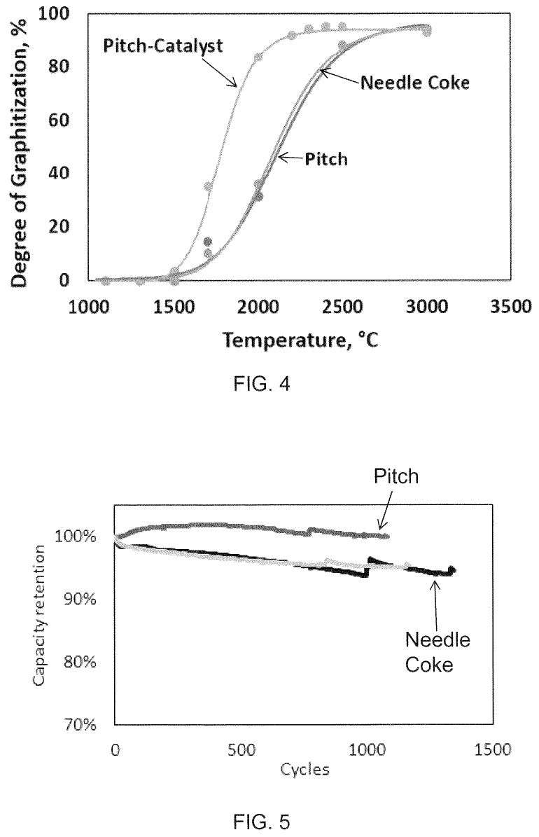

The extent of graphitization as a function of temperature in the presence or in the absence of a graphitization catalyst was also investigated. As shown in Table 2, mesophase pitch and needle coke (Samples C1 and C2 from Table 2) produced a similar amount of graphitization under un-catalyzed graphitization across temperature ranges up to 3000° C. In the presence of 2 wt. % catalyst (Sample E1-9 from Table 1), a similar amount of graphitization was realized, except at up to 800° C. lower graphitization temperature (FIG. 4). The rate of graphitization is also enhanced at lower temperatures with an initial increase in degree of graphitization observed at around 1500° C. compared to around 1600° C. for uncatalyzed samples (C1 and C2). FIG. 5 is a graph of capacity retention versus discharge cycles.

The graphitized composite powders with graphitization catalysts exhibit a smaller crystal size and thickness at the same degree of graphitization as graphite powders made from pure carbon sources. Moreover, the graphite made from carbon with catalyst display a lower extent of anisotropy evident by a smaller I(101)/I(100) peak ratio from XRD patterns. The present properties suggest that the graphite made from catalyzed samples exhibit a higher surface area and more planar edges despite getting to the same extent of graphitization. Typically, temperatures greater than 2800° C. are required to achieve >90% degree of graphitization, which in return is accompanied by further growth of graphite crystals. Displaying a high degree of graphitization (>90%) while maintaining isotropy and small crystal size is a unique feature of the graphite made from catalyzed samples making them novel products in nature. The unique structure of the graphite made from the catalyzed samples suggests that it will display an enhanced conductivity and potentially an extended cycle life compared to typical graphite from pure carbon sources.

All graphitized samples were then tested in a coin cell to determine the specific capacity and initial columbic efficiency. This data is summarized in table 3. The samples with similar degree of graphitization display similar first discharge capacities and initial columbic efficiencies, suggesting that the graphite made from catalyzed samples meets the requirements for battery-grade anode materials.

Three graphitized samples with a degree of graphitization greater than 90%, two from pure carbon precursor and one from a carbon-catalyst precursor, were tested in a pouch cell to assess the conductivity and rate capability of the sample. The conductivity of these cells is assessed by a charge and discharge mapping protocol. For charge mapping, the cells are charged at varying rates starting at 0.1 C (10 hours) and up to 6 C (10 mins), followed by a fixed discharge at 0.1 C at which the capacity retention is measured. For discharge mapping, the cells are charged at a fixed rate of 0.1 C followed by constant voltage step until 0.05 C to achieve 100% charging, after which the discharge rate is varied between 0.1 C and up to 3 C (20 mins). The cycle life is assessed at a fixed 1 C (1 hour) followed by a constant voltage step until 0.05 C for charge and 1 C for discharge. The results (Tables 4 and 5) show that graphite made from carbon-catalyst precursors are showing a higher capacity retention at both high charge and discharge rates compared to graphite made from incumbent carbon materials. The advantaged performance implies that the graphite made from catalyzed samples is structurally and compositionally different than incumbents, resulting in a different intercalation and electrochemical mechanism in the anode. These results are consistent with the expectations based on the crystal size and anisotropy XRD data on the graphite samples.

TABLE 2

| | | | | Temperature (° C.) | | | | | | | |
|---|---|---|---|---|---|---|---|---|---|---|---|
| Sample ID | | 1100 | 1500 | 1600 | 1700 | 1800 | 2000 | 2200 | 2400 | 2500 | 3000 |
| C1 | Graphitization | 0 | 0 | — | 14.7 | — | 31.4 | 69.8 | — | 88.4 | 94.2 |
| C2 | (%) | 0 | 0 | — | 10.1 | — | 36 | 70.9 | — | 88.4 | 94.2 |
| E1 | | 0 | 3.5 | — | 35.2 | — | 83.7 | 91.9 | 95.3 | 95.3 | 93 |
| E2 | | 0 | | 17.6 | | 20.7 | 42.8 | 81.2 | — | — | — |
| E3 | | 0 | — | 21.2 | — | — | — | 78.6 | — | — | — |
| E4 | | 0 | — | 12.3 | — | — | — | 79.9 | — | — | — |
| E5 | | 0 | — | 15.2 | — | — | — | 73.3 | — | — | — |
| E6 | | 0 | — | 13.4 | | 23.3 | 40.8 | 80.8 | — | — | — |
| E7 | | 0 | — | 19.4 | | 24.3 | 44.9 | 80.1 | — | — | — |
| E8 | | 0 | — | 10.9 | — | — | — | 75.0 | — | — | — |
| E9 | | 0 | — | 16.0 | — | — | — | 77.0 | — | — | — |

TABLE 3

| | | | | | First | Initial |
|---|---|---|---|---|---|---|
| | Graphitization | Crystallite | | | Discharge | Cycle |
| Sample | Temperature | Thickness, | Crystallite | Anisotropy, | Capacity | Efficiency |
| ID | (° C.) | nm | Size, nm | I101/I100 | (mAh/g) | (%) |
| C1 | 3000 | >100 | >100 | 1.18 | 347 | 96 |
| C2 | 3000 | >100 | >100 | 1.31 | 348 | 96 |
| E1 | 2500 | 72.3 | 72.7 | 0.92 | 341 | 93 |
| E2 | 2200 | 40.7 | 26.4 | 0.73 | 282 | 93 |
| E3 | | 50.5 | 28.4 | 0.92 | 262 | 95 |
| E4 | | 51.3 | 20.8 | 0.65 | 244 | 96 |
| E5 | | 33.4 | 11.1 | 0.66 | 229 | 95 |
| E6 | | 45.0 | 21.8 | 0.58 | 273 | 94 |
| E7 | | 38.9 | 23.5 | 0.77 | 277 | 93 |
| E8 | | 35.8 | >100 | 0.28 | 245 | 95 |
| E9 | | 39.7 | 20.4 | 0.83 | 263 | 94 |

TABLE 4

Capacity Retention, %

| Sample ID | 0.1 C | 0.2 C | 0.5 C | 1 C | 2 C | 3 C |
|---|---|---|---|---|---|---|
| C1 | 100 | 98 | 95 | 91 | 86 | 79 |
| C2 | 100 | 98 | 95 | 91 | 85 | 71 |
| E1 | 100 | 100 | 99 | 98 | 95 | 91 |

TABLE 5

| Sample | Capacity Retention, % | | | | | | | | |
|---|---|---|---|---|---|---|---|---|---|
| ID | 0.1 C | 0.2 C | 0.5 C | 1 C | 2 C | 3 C | 4 C | 5 C | 6 C |
| C1 | 100 | 98 | 93 | 85 | 79 | 66 | 51 | 31 | 9 |
| C2 | 100 | 100 | 96 | 88 | 82 | 71 | 57 | 44 | 27 |
| E1 | 100 | 99 | 97 | 90 | 81 | 76 | 75 | 68 | 59 |

Table 4 is capacity retention as a function discharging rate. Higher C-rate is faster discharging. In table 4, 0.1 C is discharging for 10 hours, 0.2 C is discharging for 5 hours, 0.5 C is discharging for 2 hours, 1 C is discharging for 1 hour, 2 C is discharging for 30 mins, and 3 C is discharging for 20 mins.

Table 5 is capacity retention as a function charging rate. Higher C-rate is faster charging where 0.1 C is charging for 10 hours, 0.2 C is charging for 5 hours, 0.5 C is charging for 2 hours, 1 C is charging for 1 hour, 2 C is charging for 30 mins, 3 C is charging for 20 mins, 4 C is charging for 15 mins, 5 C is charging for 12 mins, and 6 C is charging for 10 mins.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is:

1. A composite powder for an electrode comprising:
about 0.1 wt. % to about 30 wt. % graphitization catalyst or a precursor thereof, based on a total mass of the composite powder; and
about 20 wt. % to 99.9 wt. % petroleum pitch, based on a total mass of the composite powder, wherein the graphitization catalyst or the precursor thereof is dispersed in a matrix comprising the petroleum pitch, and the petroleum pitch comprises a plurality of pitch particles, wherein the composite powder has an extent of anisotropy evident by a I(101)/I(100) peak ratio from about 0.2 to about 0.99 from X-ray diffraction (XRD) patterns.

2. The composite powder of claim 1, wherein the petroleum pitch comprises about 50 wt. % or greater mesophase pitch.

3. The composite powder of claim 1, wherein the graphitization catalyst or the precursor thereof is dispersed in an interstitial space between the pitch particles.

4. The composite powder of claim 1, wherein at least a portion of the graphitization catalyst or the precursor thereof is dispersed within an interior of the pitch particles, wherein the graphitization catalyst or the precursor thereof comprises an oxide, a carbide, a salt, a coordination compound, or any combination thereof.

5. The composite powder of claim 1, wherein the pitch particles have a particle size D₅₀ ranging from about 1 □m to about 25 □m.

6. The composite powder of claim 1, wherein the composite powder comprises about 0.1 wt. % to about 10 wt. % graphitization catalyst, wherein the graphitization catalyst or the precursor thereof comprises a compound containing at least one of a Group 2 element, a Group 4 element, a Group 5 element, a Group 6 element, a Group 7 element, a Group 8 element, a Group 9 element, a Group 10 element, a Group 13 element, Cu, Zn, or Si.

7. The composite powder of claim 1, wherein the graphitization catalyst or the precursor thereof comprises a boron, iron, titanium, zirconium, manganese, nickel, cobalt, molybdenum, vanadium-containing compound, or any combination thereof.

8. The composite powder of claim 1, wherein the graphitization catalyst comprise a boron-containing compound selected from the group consisting of boric acid, sodium tetraborate, tetrahydroxyborate salts, orthoborate salts, metaborate salts, triborate salts, tetraborate salts, pentaborate salts, octaborate salts, boronic acids, boronate esters, boron oxides, boron carbides, and combinations thereof.

9. A method for forming a composite powder for an electrode comprising:
forming a blend comprising about 0.1 wt. % to about 35 wt. % graphitization catalyst or a precursor thereof and about 20 wt. % to about 99.9 wt. % petroleum pitch, each based on a total mass of the blend; and
processing the blend under grinding conditions to form a composite powder, wherein the graphitization catalyst is dispersed in a matrix comprising the petroleum pitch and the petroleum pitch comprises a plurality of pitch particles, wherein the composite powder has an extent of anisotropy evident by a I(101)/I(100) peak ratio from about 0.2 to about 0.99 from X-ray diffraction (XRD) patterns.

10. The method of claim 9, wherein forming the blend comprises melt blending the graphitization catalyst or the precursor thereof and the petroleum pitch in a melt extruder at or above the softening temperature of the petroleum pitch to disperse the graphitization catalyst or the precursor thereof in a continuous pitch matrix, and processing the blend under the grinding conditions comprises grinding the continuous pitch matrix to form the pitch particles with at least a portion of the graphitization catalyst or the precursor thereof dispersed within an interior of the pitch particles.

11. The method of claim 9, wherein the petroleum pitch comprises about 50 wt. % or greater mesophase pitch.

12. The method of claim 9, wherein forming a blend is performed at a temperature inferior to 23° C.

13. The method of claim 9, wherein the composite powder comprises about 0.1 wt. % to about 10 wt. % graphitization catalyst or the precursor thereof, and wherein the graphitization catalyst is up to about 500 nm in size before blending.

14. The method of claim 9, wherein the graphitization catalyst comprises a boron-containing compound selected from the group consisting of boric acid, sodium tetraborate, tetrahydroxyborate salts, orthoborate salts, metaborate salts, triborate salts, tetraborate salts, pentaborate salts, octaborate salts, boronic acids, boronate esters, boron oxides, boron carbides, and combinations thereof.

15. The method of claim 9, further comprising:
heating the composite powder at a temperature ranging from about 180° C. to about 450° C. in an environment containing about 0.1 mol % to about 5 mol % oxygen.

16. The method of claim 9, further comprising:
at least partially carbonizing the composite powder at a carbonization temperature ranging from about 700° C. to about 1800° C. in an environment comprising about 0.1 mol % oxygen or below to at least partially convert the petroleum pitch to amorphous carbon with a degree of graphitization up to 60%.

17. The method of claim 16, further comprising:
after at least partially carbonizing the composite powder, heating at a graphitization temperature above the carbonization temperature in an environment comprising about 0.1 mol % oxygen or below to convert at least a portion of the amorphous carbon into graphite.

18. The method of claim 17, wherein about 80 wt. % or more of the petroleum pitch in the composite powder is converted to graphite.

19. The method of claim 17, wherein the graphitization temperature is at a point in a range of from about 1800° C. to about 3400° C.

20. The method of claim 17, wherein heating at the graphitization temperature takes place for about 0.1 hour to about 8 hours.

21. An electrode material comprising:
up to about 35 wt. % graphitization catalyst comprising a Group 13 element dispersed in a carbon matrix, based on a total mass of the electrode material, wherein the electrode material is optionally coated using an amorphous carbon, wherein the carbon matrix has an extent of anisotropy evident by a I(101)/I(100) peak ratio from about 0.2 to about 0.99 from X-ray diffraction (XRD) patterns.

22. The electrode material of claim 21, wherein a surface of the electrode material is devoid of nitrides and carbides.

23. The electrode material of claim 21, wherein a graphite crystal size and thickness is up to 70% smaller than neat carbon precursors.

24. A lithium-ion battery comprising the electrode material of claim 21.

25. The lithium-ion battery of claim 24, wherein a capacity retention is up to 91% at 3 C discharging rate.

26. The lithium-ion battery of claim 24, wherein a capacity retention is up to 59% at 6 C charging rate.

27. A method of producing an electrode material comprising:
providing a composite powder comprising:
about 0.1 wt. % to about 30 wt. % graphitization catalyst or a precursor thereof, based on a total mass of the composite powder; and
about 20 wt. % to 99.9 wt. % petroleum pitch, based on a total mass of the composite powder, wherein the graphitization catalyst or the precursor thereof is dispersed in a matrix comprising the petroleum pitch, and the petroleum pitch comprises a plurality of pitch particles, wherein the composite powder has an extent of anisotropy evident by a I(101)/I(100) peak ratio from about 0.2 to about 0.99 from X-ray diffraction (XRD) patterns; and
heating the composite powder at a carbonization temperature sufficient to form a carbon matrix, wherein the heating occurs in an environment comprising about 0.1 mol % oxygen or below,
wherein the graphitization catalyst precursor, if present, is converted to the graphitization catalyst while forming the carbon matrix.

28. The method of claim 27, wherein a graphitization temperature is at a point in a range of from about 1800° C. to about 3400° C.

29. The method of claim 27, wherein a degree of graphitization greater than 90% is achieved at temperatures 2200° C. or higher.

30. The method of claim 27, wherein a degree of graphitization greater than 90% is achieved within 0.1 hours.
